(19) United States
(12) Patent Application Publication
(10) Pub. No.: US 2002/0175632 A1
(43) Pub. Date: Nov. 28, 2002

(54) Led backlight

(75) Inventor: Toshitaka Takeguchi, Shizuoka (JP)

Correspondence Address: SUGHRUE MION, PLLC, 2100 Pennsylvania Avenue, NW, Washington, DC, 20037-3213, US

(73) Assignee: YAZAKI CORPORATION

(21) Appl. No.: 10/152,331

(22) Filed: May 22, 2002

(30) Foreign Application Priority Data
May 22, 2001 (JP) P2001-152640

(51) Int. Cl. G09G 3/10

(52) U.S. Cl. 315/169.1

(57) ABSTRACT

A flat rectangular light guide plate (3) is placed on the side of the rear face of a flat rectangular LCD (1), and four kinds of LEDs having different luminous colors (a red LED (5a), a blue LED (5b), a green LED (5c), and a white LED (5d) are placed on the four side faces of the light guide plate (3) in a one to one relationship between the four kinds of LEDs and the four side faces.

### BACKGROUND OF THE INVENTION

The present invention relates to an LED backlight which is to be used together with a liquid crystal display element (hereinafter, abbreviated to LCD), and in which light emitting diodes (hereinafter, abbreviated to LEDs) are used, and more particularly to an LED backlight which can change the display color of monochrome liquid crystal without lowering brightness.

Conventionally, an LED backlight which is thinned by using the side light system has been known. FIGS. 11A and 11B show an example of a conventional LED backlight of this kind. In the LED backlight shown in FIGS. 11A and 11B, a plurality of, for examples three grooves 104 are formed in one side face of a flat rectangular light guide plate 103 which is placed on the side of the rear face of a flat rectangular LCD 101, and three LEDs 105 which are to be fitted into the three grooves 104 are disposed. The three LEDs 105 are attached to a wiring board 107, and electrically connected to the wiring board 107.

In the thus configured LED backlight, light emitted from the three LEDs 105 which are placed on one side face of the light guide plate 103 is guided to the light guide plate 103, and the light guide plate 103 emits light from the whole face, thereby performing the function of a backlight for the LCD 101 which is placed on the plate.

FIGS. 12A and 12B show another example of a conventional LED backlight. In the LED backlight shown in FIG. 12, a plurality of, for example, three grooves 104a and 104b are formed in two or upper and lower side faces of a flat rectangular light guide plate 103, three LEDs 105a which are to be fitted into the three grooves 104a are disposed, and three LEDs 105b which are to be fitted into the three grooves 104b are disposed. The three LEDs 105a are attached to a wiring board 107a, and electrically connected to the wiring board 107a. The three LEDs 105b are attached to a wiring board 107b, and electrically connected to the wiring board 107b.

In the thus configured LED backlight, light emitted from the three LEDs 105a and 105b which are placed on the upper and lower side faces of the light guide plate 103 is guided to the light guide plate 103, and the light guide plate 103 emits light from the whole face, thereby performing the function of a backlight for the LCD 101 which is placed on the plate.

In the LED backlight of FIGS. 11 or 12 configured as described above, when a red LED, a blue LED, and a green LED are disposed, an arbitrary color can be obtained by using the three primary colors, red, green, and blue.

Since the three primary colors, red, green, and blue are used, however, only colors based on the primary colors can be expressed as luminous colors, and so-called neutral colors such as pink and pale green cannot be expressed.

### SUMMARY OF THE INVENTION

The invention has been conducted in order to solve the above-discussed problem. It is an object of the invention to provide an LED backlight in which LEDs of different colors, red, green, blue, and white are used as light sources, so that neutral colors can be expressed without lowering brightness.

In order to attain the object, the LED backlight of a first aspect of the invention is characterized in that a flat light guide plate is placed on a side of a rear face of a flat liquid crystal display element, and four kinds of LEDs having different luminous colors are placed on four side faces of the light guide plate in a one to one relationship between the four kinds of LEDs and the four side faces.

According to the first aspect of the invention, since the four kinds of LEDs having different luminous colors are placed on the four side faces in a one to one relationship between the four kinds of LEDs and the four side faces, the luminous colors of the LEDs on the four side faces are different from each other depending on the side faces. Light emitted from each LED is guided to the light guide plate, and the light guide plate emits light from the whole face. Namely, neutral colors can be expressed by the four luminous colors.

The LED backlight of a second aspect of the invention is characterized in that a flat light guide plate is placed on a side of a rear face of a flat liquid crystal display element, and four kinds of LEDs having different luminous colors are placed on at least one of four side faces of the light guide plate.

According to the second aspect of the invention, since the four kinds of LEDs having different luminous colors are placed on at least one of the four side faces of the light guide plate, the luminous colors of the four kinds of LEDs placed on each side face are different from each other. Light emitted from each LED is guided to the light guide plate, and the light guide plate emits light from the whole face. Namely, neutral colors can be expressed by the four luminous colors.

The LED backlight of a third aspect of the invention is characterized in that, in the LED backlight of the first or second aspect of the invention, the four kinds of LEDs are a red LED, a green LED, a blue LED, and a white LED.

According to the third aspect of the invention, since the four kinds of LEDs are a red LED, a green LED, a blue LED, and a white LED, neutral colors such as pink and pale green can be expressed without lowering brightness.

The LED backlight of a fourth aspect of the invention is characterized in that, in the LED backlight of the third aspect of the invention, the LED backlight has an LED controller which controls lighting times of the red LED, the green LED, the blue LED, and the white LED.

According to the fourth aspect of the invention, since the LED controller controls the lighting time of each of the red, green, blue, and white LEDs, the luminous color can be arbitrarily changed.

The LED backlight of a fifth aspect of the invention is characterized in that, in the LED backlight of any one of the first to fourth aspects of the invention, grooves are formed in the side faces, the LEDs are fitted into the grooves, and the LEDs are attached to a wiring board to which the LEDs are electrically connected.

According to the fifth aspect of the invention, since the LEDs attached to the wiring board are mounted with being fitted into the grooves formed in the side faces, the LED backlight can be miniaturized and thinned.

The LED backlight of a sixth aspect of the invention is characterized in that a flat light guide plate is placed on a side of a rear face of a flat liquid crystal display element, and an LED package in which three kinds of LEDs having different luminous colors are integrated with one another is mounted on at least one of four side faces of the light guide plate.

In the LED backlight of the sixth aspect of the invention, since three kinds of LEDs are accommodated in one LED package with being integrated with one another, white light can be emitted, so that neutral colors such as pink and pale green can be expressed without using a white LED.

The LED backlight of a seventh aspect of the invention is characterized in that, in the LED backlight of the sixth aspect of the invention, the three kinds of LEDs of the LED package are a red LED, a green LED, and a blue LED, one LED package emits white light, and another LED package emits light of a color other than white.

In the LED backlight of the seventh aspect of the invention, white light is emitted by combining luminous colors of the red, green, and blue LEDs with one another, and neutral colors such as pink and pale green can be expressed by the white color and other colors.

The LED backlight of an eighth aspect of the invention is characterized in that, in the LED backlight of the seventh aspect of the invention, the LED backlight has an LED controller which controls lighting times of the red LED, the green LED, and the blue LED.

In the LED backlight of the eighth aspect of the invention, since the LED controller controls the lighting time of each of the red, green, and blue LEDs, the luminous color can be arbitrarily changed.

The LED backlight of a ninth aspect of the invention is characterized in that, in the LED backlight of any one of the sixth to eighth aspects of the invention, grooves are formed in the side faces, the LEDs are fitted into the grooves, and the LEDs are attached to a wiring board to which the LEDs are electrically connected.

In the LED backlight of the ninth aspect of the invention, since the LEDs attached to the wiring board are mounted with being fitted into the grooves formed in the side faces, the LED backlight can be miniaturized and thinned.

### BRIEF DESCRIPTION OF THE DRAWINGS

FIGS. 1A and 1B are views showing the configuration of an LED backlight of a first embodiment of the invention, FIG. 1A being a plan view of the LED backlight, and FIG. 1B being a side view of the LED backlight.

FIG. 2 is a diagram showing an example of a timing chart of lighting control signals for controlling lighting of LEDs of four colors disposed in the LED backlight of the first embodiment of the invention.

FIG. 3 is a view showing the configuration of an LED backlight of a second embodiment of the invention.

FIG. 4 is a diagram showing lighting control signals for LEDs of the LED backlight of the second embodiment.

FIG. 5 is a view showing an example of the manner of mounting LEDs on a light guide plate.

FIG. 6 is a view showing an example of the manner of mounting LEDs attached to a wiring plate, on a light guide plate.

FIG. 7 is a view showing an example of the manner of mounting LED chips attached to a wiring plate, on a light guide plate.

FIG. 8 is a view showing the configuration of an LED backlight of a third embodiment of the invention.

FIG. 9 is a view showing the configuration of an LED package disposed in the LED backlight of the third embodiment.

FIG. 10 is a view showing the configuration of an LED backlight of a fourth embodiment of the invention.

FIGS. 11A and 11B are views showing the configuration of an example of a conventional LED backlight, FIG. 11A being a plan view thereof and FIG. 11B being a side view thereof.

FIGS. 12A and 12B are views showing the configuration of another example of a conventional LED backlight, FIG. 12A being a plan view thereof and FIG. 12B being a side view thereof.

### DETAILED DESCRIPTION OF PREFERRED EMBODIMENTS

Hereinafter, LED backlights of embodiments of the invention will be described in detail with reference to the accompanying drawings. The LED backlights of the embodiments are characterized in that the thickness is reduced by using the side light system, and LEDs of different colors, red, green, blue, and white are used as light sources to constitute a backlight source of an arbitrary color, whereby neutral colors can be expressed without lowering brightness.

First Embodiment

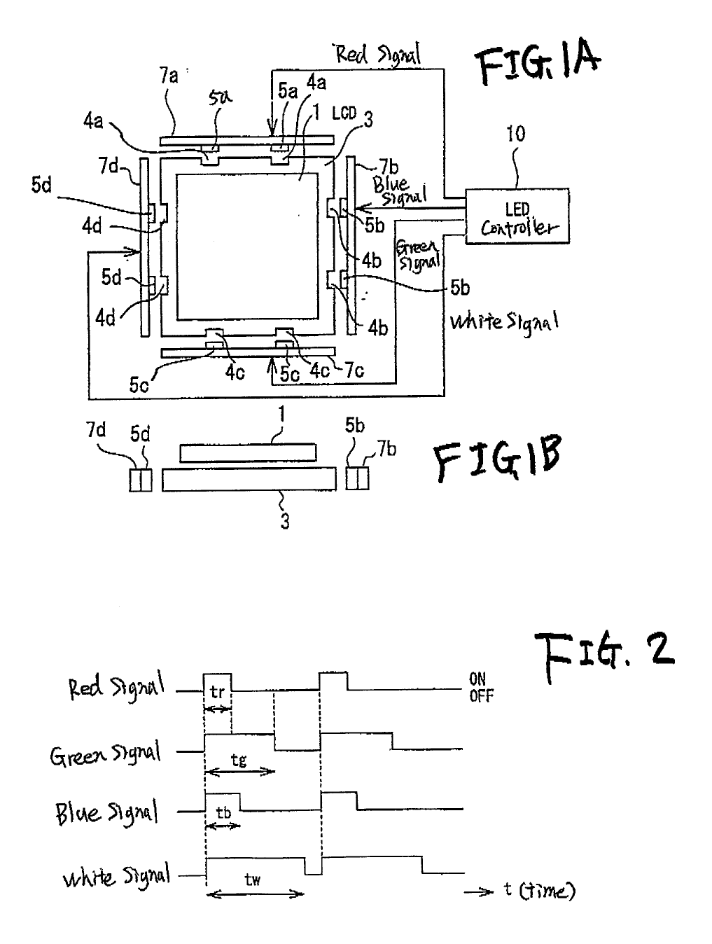

FIG. 1 is a view showing the configuration of an LED backlight of a first embodiment of the invention. In the figure, FIG. 1A is a plan view of the LED backlight, and FIG. 1B is a side view of the LED backlight.

In the LED backlight shown in FIGS. 1A and 1B, a flat rectangular light guide plate 3 is placed on the side of the rear face of a flat rectangular LCD 1. A plurality of, for example, two grooves 4a are formed in the upper one of the four side faces of the light guide plate 3, a plurality of, for example, two grooves 4b are formed in the right side face, a plurality of, for example, two grooves 4c are formed in the lower side face, and a plurality of, for example, two grooves 4d are formed in the left side face.

Two red LEDs 5a which are to be respectively fitted into the two grooves 4a are disposed. The two red LEDs 5a are attached to a wiring board 7a, and electrically connected to the wiring board 7a.

Two blue LEDs 5b which are to be respectively fitted into the two grooves 4b are disposed. The two blue LEDs 5b are attached to a wiring board 7b, and electrically connected to the wiring board 7b.

Two green LEDs 5c which are to be respectively fitted into the two grooves 4c are disposed. The two green LEDs 5c are attached to a wiring board 7c, and electrically connected to the wiring board 7c.

Two white LEDs 5d which are to be respectively fitted into the two grooves 4d are disposed. The two white LEDs 5d are attached to a wiring board 7d, and electrically connected to the wiring board 7d.

An LED controller 10 which controls lighting of the red, blue, green, and white LEDs 5a to 5d is disposed. As a lighting control signal for controlling lighting of each of the LEDs 5a to 5d of the respective colors, a red signal is supplied to the two red LEDs 5a via the wiring board 7a, a blue signal is supplied to the two blue LEDs 5b via the wiring board 7b, a green signal is supplied to the two green LEDs 5c via the wiring board 7c, and a white signal is supplied to the two white LEDs 5d via the wiring board 7d. FIG. 2 shows an example of a timing chart of the lighting control signals for controlling lighting of the LEDs 5a to 5d of the four colors.

Next, the operation of the thus configured LED backlight of the first embodiment will be described. First, the two red LEDs 5a attached to the wiring board 7a are fitted into the two grooves 4a, the two blue LEDs 5b attached to the wiring board 7b are fitted into the two grooves 4b, the two green LEDs 5c attached to the wiring board 7c are fitted into the two grooves 4c, and the two white LEDs 5d attached to the wiring board 7d are fitted into the two grooves 4d, respectively.

In accordance with the lighting control signal supplied from the LED controller 10, the LEDs light up, so that the luminous color in the upper side face is red, that in the right side face is blue, that in the lower side face is green, and that in the left side face is white. Furthermore, light emitted from the LEDs is guided to the light guide plate 3, and the light guide plate 3 emits light from the whole face, thereby performing the function of a backlight for the LCD 1 which is placed on the plate.

In this case, as shown in FIG. 2, for example, lighting times of the red signal (lighting time tr), the green signal (lighting time tg), the blue signal (lighting time tb), and the white signal (lighting time tw) are adjusted by using the PWM system to change the mixture ratio, whereby an arbitrary color can be expressed.

In the case of green and red, for example, the color is orange, and, when the lighting time of the red signal is prolonged, the color is reddish to become close to vermillion. When white is further added to the color, the color is pale orange. In the case of blue and red, the color is purple. When the lighting times are changed, a more delicate color can be expressed.

As described above, in the LED backlight of the first embodiment, the thickness is reduced by using the side light system, and LEDs of different colors, red, green, blue, and white are used as light sources to constitute a backlight source of an arbitrary color, whereby the display color of monochrome liquid crystal can be changed to an arbitrary one without lowering brightness. Namely, neutral colors such as pink and pale green can be expressed. As a result, the variety of displayed contents is increased, and the manner of expression is enhanced.

Since light enters in the four directions, the brightness of the backlight is higher than in a LED backlight in which light enters in two directions as shown in FIG. 8, and hence the LCD 1 can be made brighter.

Since the LEDs 5a and the like attached to the wiring board 7a and the like are mounted with being fitted into the grooves 4a and the like formed in the side faces, the LED backlight can be miniaturized and thinned.

Second Embodiment

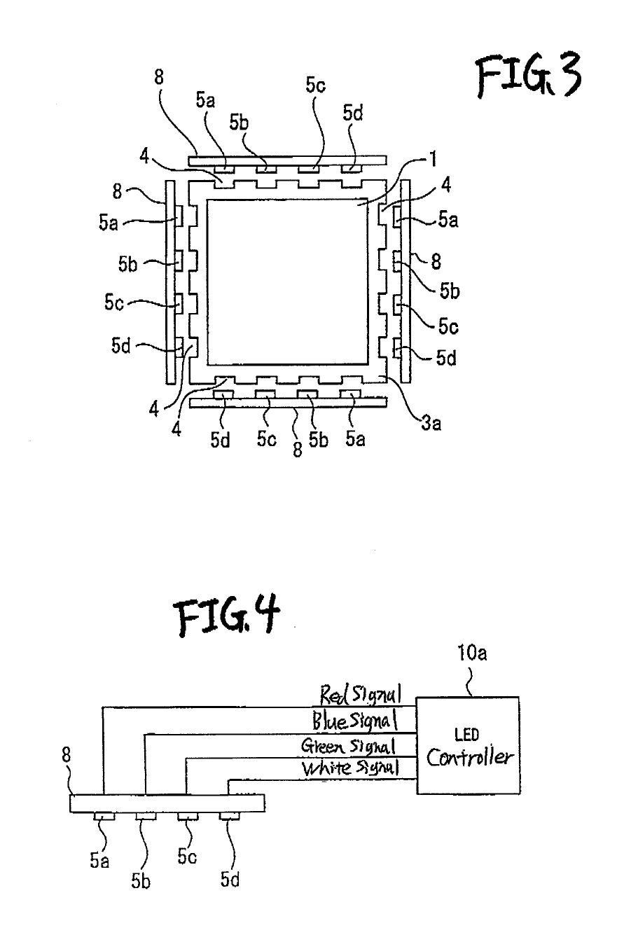

FIG. 3 is a view showing the configuration of an LED backlight of a second embodiment of the invention. In the LED backlight shown in FIG. 3, a flat rectangular light guide plate 3 is placed on the side of the rear face of a flat rectangular LCD 1. A plurality of, for example, four grooves 4 are formed in each of the four side faces of the light guide plate 3. Four wiring boards 8 are disposed so as to respectively correspond to the four side faces.

A red LED 5a, a blue LED 5b, a green LED 5c, and a white LED 5d are attached to each of the wiring boards 8. The red LED 5a, the blue LED 5b, the green LED 5c, and the white LED 5d are fitted into the four grooves 4, respectively.

As shown in FIG. 4, an LED controller 10a supplies a red signal to the red LED 5a, a blue signal to the blue LED 5b, a green signal to the green LED 5c, and a white signal to the white LED 5d. As described in the LED backlight of the first embodiment, the red, blue, green, and white signals are configured by the signals shown in FIG. 2, respectively.

Next, the operation of the thus configured LED backlight of the second embodiment will be described. First, the red LED 5a, the blue LED 5b, the green LED 5c, and the white LED 5d which are attached to each of the wiring boards 8 are fitted into the corresponding four grooves 4.

In accordance with the lighting control signal supplied from the LED controller 10a, the LEDs light up, so that the luminous colors in each of the four faces are four colors, or red, blue, green, and white. Furthermore, light emitted from the LEDs is guided to the light guide plate 3, and the light guide plate 3 emits light from the whole face, thereby performing the function of a backlight for the LCD 1 which is placed on the plate.

Therefore, the LED backlight of the second embodiment can attain the same effects as those of the LED backlight of the first embodiment.

In the LED backlights of the first and second embodiments, the LEDs 5a and the like are mounted by using the wiring board 7a and the like with being fitted into the grooves 4a and the like formed in the light guide plate 3. Alternatively, as shown in FIG. 5, for example, the LEDs 5a and the like may be directly mounted without using a wiring board and with being fitted into the grooves 4a formed in the light guide plate 3.

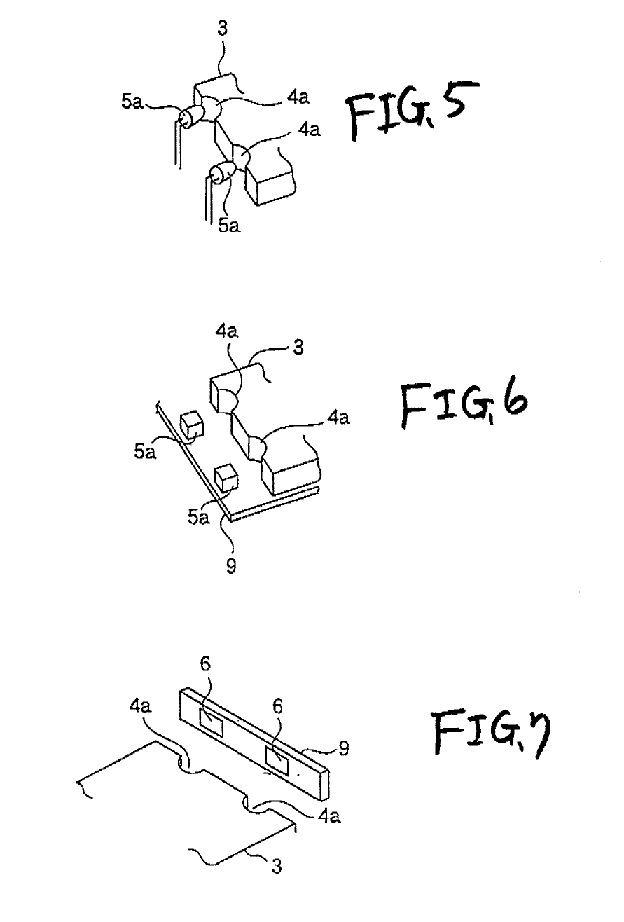

As shown in FIG. 6, alternatively, a wiring board 9 which is slightly larger than the light guide plate 3 may be placed below the light guide plate 3, and LEDs 5a attached to the wiring board 9 may be mounted with being fitted into the grooves 4a formed in the light guide plate 3.

As shown in FIG. 7, alternatively, LED chips 6 attached to a wiring board 9 may be mounted with being fitted into the grooves 4a formed in the light guide plate 3.

Third Embodiment

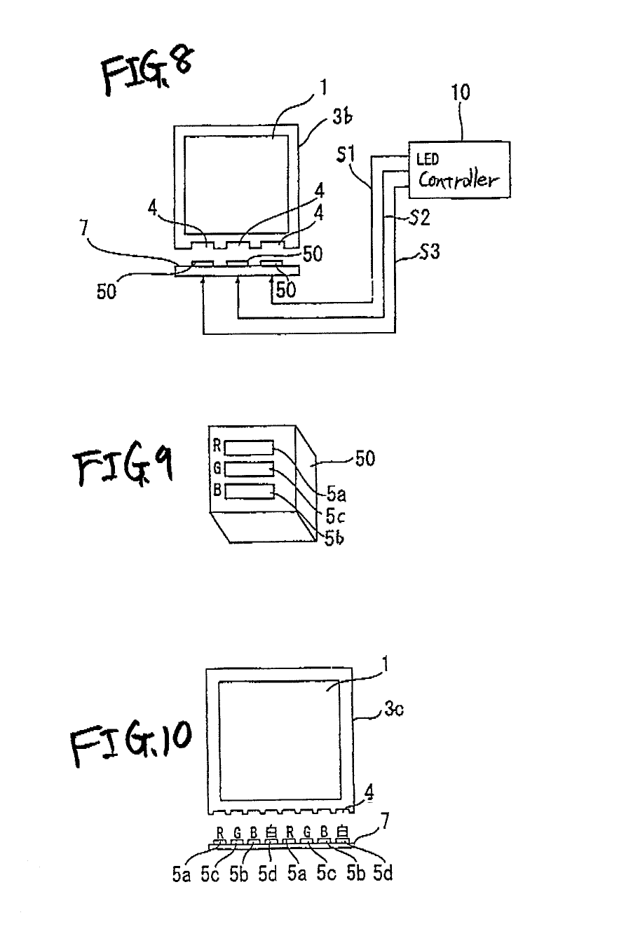

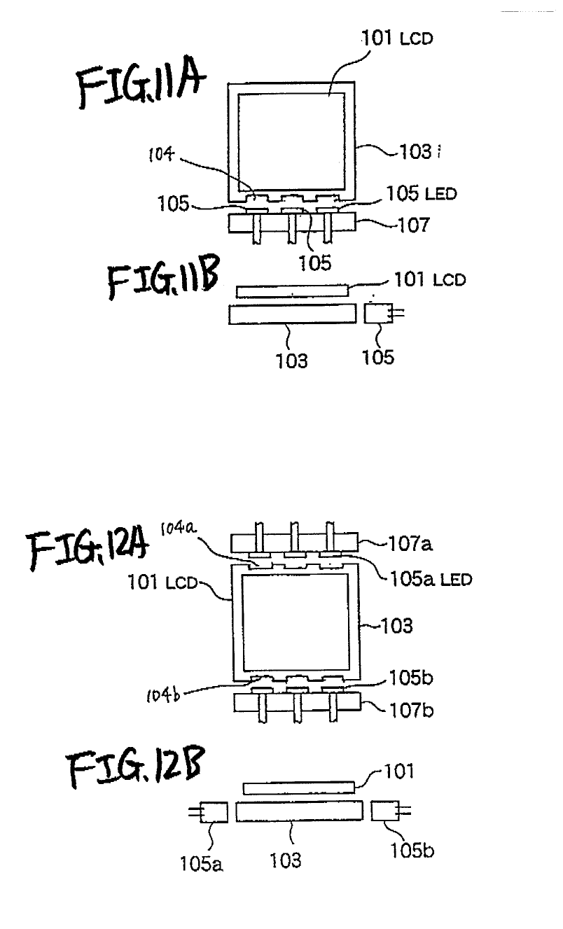

FIG. 8 is a view showing the configuration of an LED backlight of a third embodiment of the invention, and FIG. 9 is a view showing the configuration of one of LED packages disposed in the LED backlight of the third embodiment.

In the LED backlight shown in FIG. 8, a flat light guide plate 3b is placed on the side of the rear face of a flat LCD 1, three grooves 4 are formed in one of four side faces of the light guide plate 3b, and one wiring board 7 is disposed correspondingly with the one side face.

Three LED packages 50 are attached to the wiring board 7. The three LED packages 50 are fitted into the three grooves 4, respectively. In each of the LED packages 50, as shown in FIG. 9, a red LED 5a, a blue LED 5b, and a green LED 5c are integrated with one another.

An LED controller 10 supplies signals to the red LED 5a, the blue LED 5b, and the green LED 5c in each of the LED packages 50. As described in the LED backlight of the first embodiment, the signals are configured by the signals shown in FIG. 2, respectively.

In the LED backlight of the third embodiment, the three kinds of LEDs 5a, 5b, and 5c are accommodated in each one of the LED packages 50 with being integrated with one another. Therefore, the LED backlight can emit white light, so that neutral colors such as pink and pale green can be expressed without using a white LED.

White light is emitted by combining luminous colors of the red LED 5a, the green LED 5c, and the blue LED 5b with one another, and neutral colors such as pink and pale green can be expressed by the white color and other colors. Since the LED controller 10 controls the lighting time of each of the red LED 5a, the green LED 5c, and the blue LED 5b, the luminous color can be arbitrarily changed.

In place of the configuration in which the LEDs are mounted only on one side face of the light guide plate 3b, for example, a configuration may be employed in which LEDs are mounted on two, three, or four side faces of the light guide plate 3b, so that light enters in the two, three, or four directions.

Fourth Embodiment

FIG. 10 is a view showing the configuration of an LED backlight of a fourth embodiment of the invention. The LED backlight of the fourth embodiment is a modification of the LED backlight of the second embodiment, and characterized only in that the mounting of LEDs on a light guide plate 3c is restricted only to one side face of the light guide plate 3c. In the example shown in FIG. 10, two sets of four kinds of LEDs, or a red LED 5a, a green LED 5c, a blue LED 5b, and a white LED 5d are attached to a wiring board 7. The eight LEDs are mounted on the light guide plate 3c with being fitted into corresponding eight grooves 4 which are formed in one side face of the light guide plate 3c.

Also in the case where the LEDs are mounted only on one side face of the light guide plate 3c as described above, light emitted from the LEDs is guided to the light guide plate 3c, and the same effects as those of the LED backlight of the second embodiment are attained.

In place of the configuration in which the LEDs are mounted only on one side face of the light guide plate 3c, for example, a configuration may be employed in which LEDs are mounted on two or three side faces of the light guide plate 3c, so that light enters in the two or three directions.

The invention is not restricted to the LED backlights of the first to fourth embodiments described above. In the embodiments, the LCD 1 and the light guide plate 3 are formed into a rectangular shape. Their shapes are not limited to a rectangle, and may be a polygon other than a rectangle, or a circle or an oval.

According to the first aspect of the invention, since the four kinds of LEDs having different luminous colors are placed on the four side faces in a one to one relationship between the four kinds of LEDs and the four side faces, the luminous colors of the LEDs on the four side faces are different from each other depending on the side faces. Light emitted from each LED is guided to the light guide plate, and the light guide plate emits light from the whole face. Namely, neutral colors can be expressed by the four luminous colors.

According to the second aspect of the invention, since the four kinds of LEDs having different luminous colors are placed on at least one of the four side faces of the light guide plate, the luminous colors of the four kinds of LEDs placed on each side face are different from each other. Light emitted from each LED is guided to the light guide plate, and the light guide plate emits light from the whole face. Namely, neutral colors can be expressed by the four luminous colors.

According to the third aspect of the invention, since the four kinds of LEDs are a red LED, a green LED, a blue LED, and a white LED, neutral colors such as pink and pale green can be expressed without lowering brightness.

According to the fourth aspect of the invention, since the LED controller controls the lighting time of each of the red, green, blue, and white LEDs, the luminous color can be arbitrarily changed.

According to the fifth aspect of the invention, since the LEDs attached to the wiring board are mounted with being fitted into the grooves formed in the side faces, the LED backlight can be miniaturized and thinned.

In the LED backlight of the sixth aspect of the invention, since three kinds of LEDs are accommodated in one LED package with being integrated with one another, white light can be emitted, so that neutral colors such as pink and pale green can be expressed without using a white LED.

In the LED backlight of the seventh aspect of the invention, white light is emitted by combining luminous colors of the red, green, and blue LEDs with one another, and neutral colors such as pink and pale green can be expressed by the white color and other colors.

In the LED backlight of the eighth aspect of the invention, since the LED controller controls the lighting time of each of the red, green, and blue LEDs, the luminous color can be arbitrarily changed.

In the LED backlight of the ninth aspect of the invention, since the LEDs attached to the wiring board are mounted with being fitted into the grooves formed in the side faces, the LED backlight can be miniaturized and thinned.

What is claimed is:

1. An LED backlight comprising:
a flat liquid crystal display element;
a flat light guide plate disposed on a rear face side of the liquid crystal display element; and
four kinds of LEDs having different luminous colors which are disposed on four side faces of the light guide plate, respectively.

2. The LED backlight according to claim 1, wherein the four kinds of LEDs are a red LED, a green LED, a blue LED, and a white LED.

3. The LED backlight according to claim 2 further comprising an LED controller which controls lighting times of the red LED, the green LED, the blue LED, and the white LED.

4. The LED backlight according to claim 1, wherein a plurality of grooves are formed in the side faces, respectively, the LEDs are fitted into the respective grooves, and the LEDs are attached to a wiring board to which the LEDs are electrically connected.

5. An LED backlight comprising:
a flat liquid crystal display element;
a flat light guide plate disposed on a rear face side of the flat liquid crystal display element; and
four kinds of LEDs having different luminous colors which are disposed on at least one of four side faces of the light guide plate.

6. The LED backlight according to claim 5, wherein the four kinds of LEDs are a red LED, a green LED, a blue LED, and a white LED.

7. The LED backlight according to claim 6 further comprising an LED controller which controls lighting times of the red LED, the green LED, the blue LED, and the white LED.

8. The LED backlight according to claim 5, wherein a plurality of grooves are formed in the side faces, respectively, the LEDs are fitted into the respective grooves, and the LEDs are attached to a wiring board to which the LEDs are electrically connected.

9. An LED backlight comprising:
a flat liquid crystal display element;
a flat light guide plate disposed on a rear face side of the liquid crystal display element; and
a plurality of LED packages mounted on at least one of four side faces of the light guide plate, wherein three kinds of LEDs having different luminous colors which are integrated with each other are installed in each LED package.

10. The LED backlight according to claim 9, wherein the three kinds of LEDs are a red LED, a green LED, and a blue LED, one of the plurality of LED package can emit white light, and another LED package emits light of a color other than white.

11. The LED backlight according to claim 10 further comprising an LED controller which controls lighting times of the red LED, the green LED, and the blue LED.

12. The LED backlight according to claim 9, wherein a plurality of grooves are formed in the side faces, the plurality of LED packages are fitted into the grooves, respectively, and the plurality of LED packages are attached to a wiring board to which the LEDs are electrically connected.
